(19) United States
(12) Patent Application Publication
(10) Pub. No.: US 2026/0210795 A1
(43) Pub. Date: Jul. 23, 2026

(54) KINETIC EVENT REMOTE MONITORING SYSTEM

(71) Applicant: KAI SYSTEMS, Boerne, TX (US)

(72) Inventors: Cody J. BORIGO, Elizabethtown, PA (US); Steven E. OWENS, State College, PA (US); Russell LOVE, State College, PA (US)

(21) Appl. No.: 19/139,610

(22) PCT Filed: Dec. 19, 2023
(86) PCT No.: PCT/US2023/084854

§ 371 Date: Jun. 16, 2025

Related U.S. Application Data
(60) Provisional application No. 63/433,961, filed on Dec. 20, 2022.

(51) Int. Cl. G01M 5/00

(52) U.S. Cl. CPC G01M 5/0033; G01M 5/0066

(57) ABSTRACT

A sensor may include a housing having a first surface and a second surface disposed opposite the first surface. The first surface may be configured to be disposed adjacent to a structure, and the housing may define an internal cavity. At least one sensing module may be disposed within the internal cavity, and a processor may disposed within the internal cavity and in communication with the at least one sensing module. The processor may be configured to receive impact data from the at least one sensing module, determine if the impact data exceeds a threshold value, and initiate a data acquisition state if the impact data exceeds the threshold value. Systems, methods, and computer-readable media also are disclosed.

### CROSS-REFERENCE TO RELATED APPLICATION

This application claims priority to U.S. Provisional Patent Application No. 63/433,961, filed Dec. 20, 2022, the entirety of which is incorporated by reference herein.

### FIELD

The disclosed sensors, systems, and methods relate to the monitoring of structural components for kinetic events that may induce wear or damage to said components.

### BACKGROUND

Engineered assets including bridge, pier, manufacturing, and energy systems, among many others, often contain vital load-bearing components that are critical to the safe and effective operation of these structures. Throughout the course of their operational life, these critical components experience loads within their design envelope as well as loads due to kinetic events that are outside of their intended operational limits; these kinetic events could include natural disasters, weather-related phenomena, impact by other equipment, sabotage, vandalism, or overloading of the structure during operation. Asset managers are responsible for ensuring the continued health of these components throughout, and often beyond, their design life. In order to accurately assess the health of critical asset components, information on kinetic events impacting said components is a highly valuable data input, but one that is often difficult to accurately assess without explicitly monitoring the assets for such events.

Ideally, critical structural assets would be outfitted with remote health monitoring sensors that provide near-real-time, or at least periodic, data on the kinetic events to which these assets are subjected. Quantitative characterization of these kinetic events, which could include information on the acceleration, forces, rotation, deflection, or other physical variables associated with the events allows asset managers and engineers to better understand the loads experienced by these critical structural components and therefore to make more educated engineering assessments and decisions regarding maintenance and safety. Furthermore, the ability to explicitly measure and record kinetic events can allow asset managers to determine the source, and, in some cases, the responsible party for these events. This may include overloading of a structure during operation, impact of the structure with another piece of equipment or a vessel, or sabotage or vandalism of the structure.

Remote asset monitoring technologies exist in various formats, ranging from very simple temperature sensors linked to a cloud server to highly specialized systems that require expert data analysis. Preferably, a remote asset integrity monitoring system designed to detect, characterize, and report kinetic events would be sufficiently low-cost and easy to install and set up such that it can be deployed across a large percentage of critical structural components, have an extended battery life of at least several years, and allow the user to access and interpret the data without the need for specialized engineering analysis. The system would also preferably require minimal installation and setup, have an extended range for data transmission, and be adaptable to a wide range of structures, applications, and environments.

### SUMMARY

Sensors are disclosed that are configured to be mounted to critical structural components of engineered assets for the detection of kinetic events affecting said assets. The sensors may be capable of detecting and quantifying parameters such as acceleration, impact energy, tilt, and deflection that characterize the physical properties of the kinetic event and its impact on the structural component. Also disclosed are systems that may work in conjunction with said sensor(s) to automatically transmit the detected event information to an asset manager or other user. The sensors may be small, lightweight, low-cost, battery-powered, highly efficient, wireless, easily installed, easily commissioned, ruggedized, and environmentally robust. The sensors can be configured to wirelessly transmit data directly to a cloud server, to a cloud server by means of a gateway connection, including direct-to-gateway and mesh network configurations.

### BRIEF DESCRIPTION OF THE DRAWINGS

FIG. 1A is a set of isometric views of one example of a sensor in accordance with some embodiments.

FIG. 1B is a front view of one example of a sensor in accordance with some embodiments.

FIG. 1C is a set of side views of one example of a sensor in accordance with some embodiments.

FIG. 2A is an isometric view of one example of a sensor mounted on a cleat in accordance with some embodiments.

FIG. 2B is an isometric view of one example of a sensor and a cleat in accordance with some embodiments.

FIG. 3A is a set of isometric views of one example of a sensor and a cleat mounted on a cylindrical structure with straps in accordance with some embodiments.

FIG. 3B is a set of side views of one example of a sensor and a cleat mounted on a cylindrical structure in accordance with some embodiments.

FIG. 4A is an illustration of one example of a sensor body and internal electronic components in accordance with some embodiments.

FIG. 4B is an exploded view of one example of a sensor and internal electronic components in accordance with some embodiments.

FIG. 4C is a set of isometric views of one example of a printed circuit board and board-mounted components in accordance with some embodiments.

FIG. 5 is one example of an electrical schematic for a sensor in accordance with some embodiments.

FIG. 6 is a flow chart of one example of a process for transitioning a sensor from a sleep mode to a data acquisition mode in accordance with some embodiments.

FIG. 7 is a flow chart of one example of a data acquisition process in accordance with some embodiments.

FIG. 8 is a flow chart of one example of a data transmission process in accordance with some embodiments.

FIG. 9A is a diagram of one example of a direct wireless communication network with a plurality of sensors in accordance with some embodiments.

FIG. 9B is a diagram of one example of a direct-to-gateway wireless communication network with a plurality of sensors in accordance with some embodiments.

FIG. 9C is a diagram of one example of a mesh-to-gateway wireless communication network with a plurality of sensors in accordance with some embodiments.

FIGS. 10A-10C are examples of models of a single-axis accelerometer in accordance with some embodiments.

FIGS. 10D-10F are examples of models of a multi-axis accelerometer in accordance with some embodiments.

FIG. 11 is an example of a model of a gyroscope in accordance with some embodiments.

FIG. 12 shows the directions of the X-, Y-, and Z-axes for an Acc_Gyro board in accordance with some embodiments.

FIG. 13 illustrates one example of a model used for determining a measured value in accordance with some embodiments.

### DETAILED DESCRIPTION

This description of the exemplary embodiments is non-limiting and is intended to be read in connection with the accompanying drawings, which are to be considered part of the entire written description.

The disclosed sensors may be configured to be mounted to critical structural components of engineered assets for the detection of kinetic events affecting said assets. The sensors may be capable of detecting and quantifying parameters such as acceleration, impact energy, tilt, and deflection that characterize the physical properties of the kinetic event and its impact on the structural component. In some embodiments, a system may work in conjunction with said sensor to automatically transmit the detected event information to an asset manager or other user. The sensors may be small, lightweight, low-cost, battery-powered, highly efficient, wireless, easily installed, easily commissioned, ruggedized, and environmentally robust. The sensors can be configured to wirelessly transmit data directly to a cloud server, to a cloud server by means of a gateway connection, including direct-to-gateway and mesh network configurations.

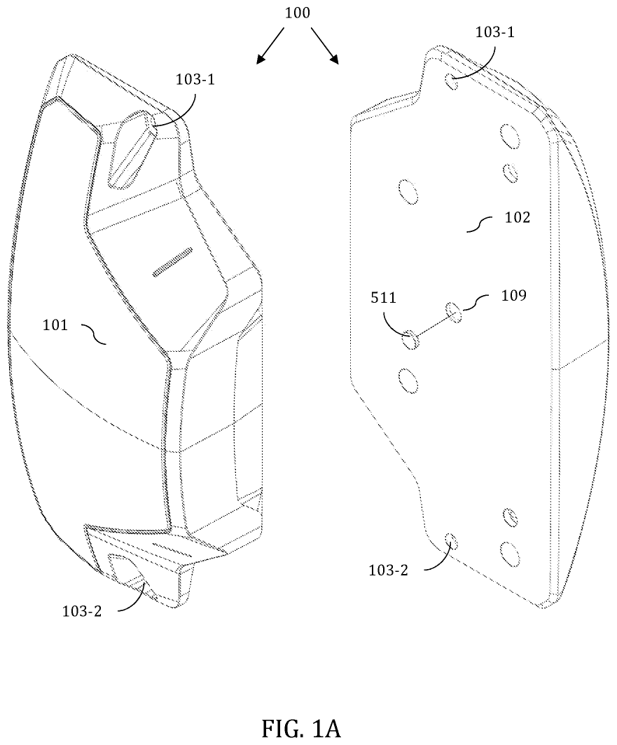

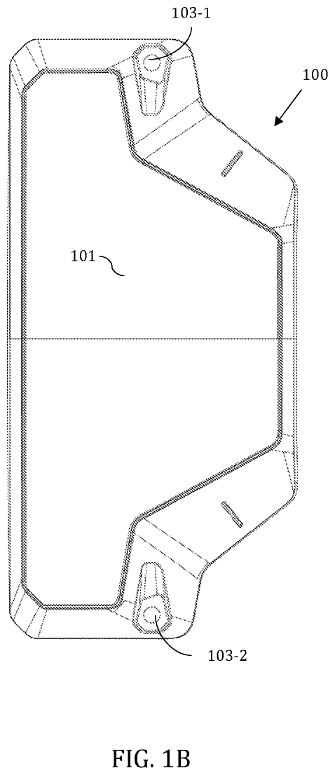

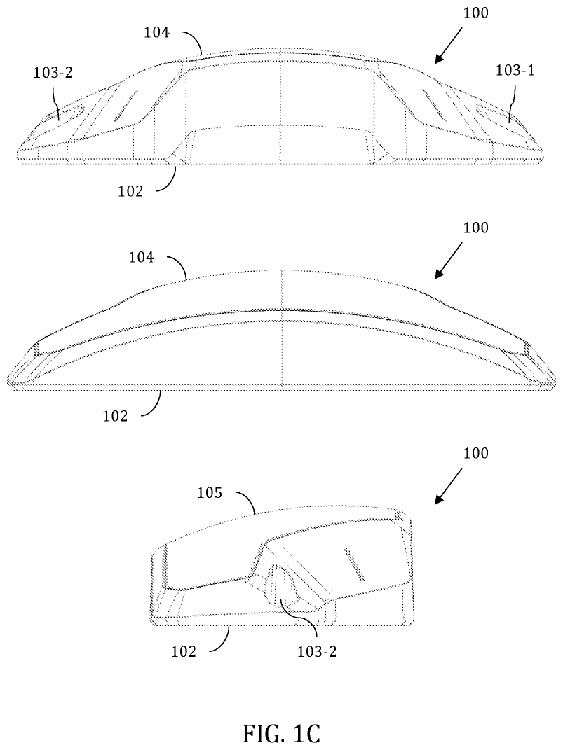

One embodiment of sensor 100 is illustrated in FIG. 1A, FIG. 1B, and FIG. 1C in which the front surface 101 and rear surface 102 are identified. Back surface 102 may be configured to be in contact with or adjacent to the structure. Front surface 101 may be low-profile in the sense that it minimally protrudes from the surface of the structure. Furthermore, front surface 101 may be curved along each direction parallel to the surface of the structure, for example, along curves 104 and 105, such that there is a reduced likelihood of objects forcefully interacting with an exposed edge of the sensor, which can result in damage to the sensor, the sensor mount, or the object or which could impede the normal function of the structure and interaction with the structure during normal operation.

Sensor 100 may be fully sealed and the internal cavities may be filled with encapsulating compound to maximize weather resistance and mechanical durability. The external surfaces of the sensor may be at least one of constructed of materials or coated with materials that are resistant to moisture, ultraviolet radiation, chemicals, and salt to withstand a wide range of environments including those found in industrial and marine environments.

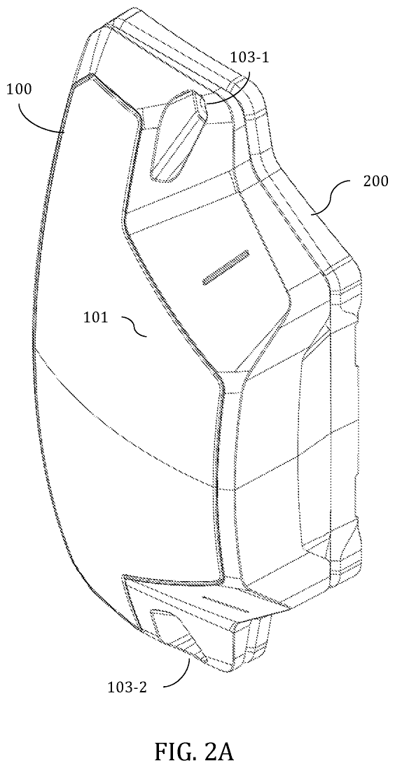

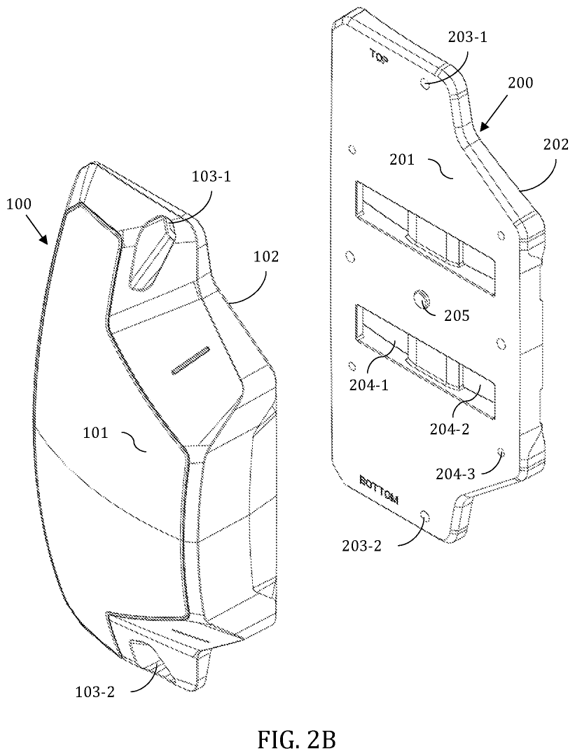

As is illustrated in FIG. 2A and FIG. 2B, sensor 100 can be mounted to a structure by means of a cleat 200 having a first (e.g., front) surface 201 and a second (e.g., rear) surface 202. The claim 200 may be configured to be located between sensor 100 and a structure such that surfaces 102 and 201 may be collocated and such that holes 103-1 and 103-2 in sensor 100 may be collocated with holes 203-1 and 203-2 in the cleat. At least one fastener can be installed from the front surface 101 into holes 103 and 203 to join sensor 100 to cleat 200. However, one of ordinary skill in the art will understand that other fastening means (e.g., mechanical and/or adhesive) may be used to couple the sensor 100 to cleat 200.

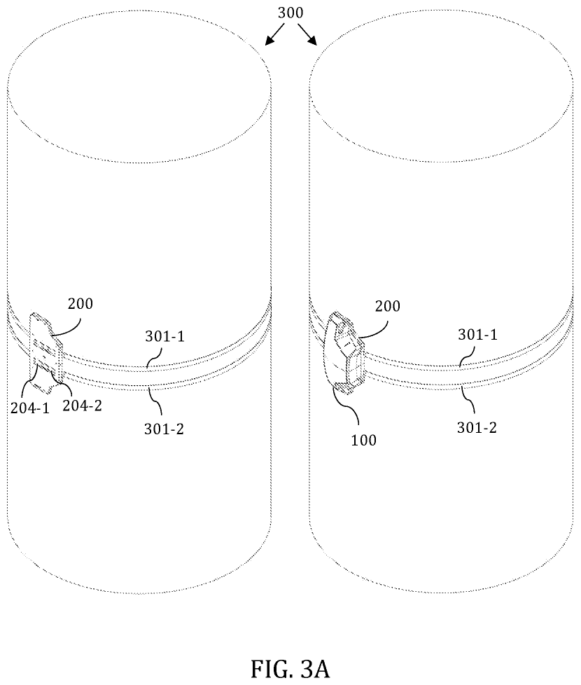

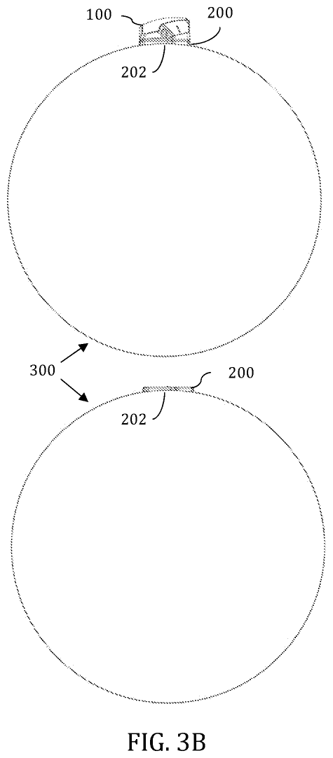

As is illustrated in FIG. 3A and FIG. 3B, cleat 200 can be utilized to mount sensor 100 on a structure 300 and may be available in one of a variety of configurations for mounting to structures having a wide range of surface geometry. The curvature of the rear surface 202 of cleat 200 can be configured to match the curvature of the structure 300 to which it will be mounted. This may provide a secure fit between the cleat 200 and the structure 300 and may minimize and/or reduce the distance by which the mounted sensor 100 protrudes above the surface of said structure.

Cleat 200 may include at least one aperture 204 through which a fastener may be inserted to attach said cleat to a structure. In some embodiments, the at least one aperture 204 comprises one or more apertures 204-1, 204-2 (collectively, “apertures”) through which at least one metallic strap 301 may be passed for the purpose of mounting cleat 200 to a cylindrical structure in contact with surface 202. In some embodiments, the at least one aperture 204 may include at least one cylindrical hole 204-3 (FIG. 2B) through which a threaded fastener may be passed for the purpose of mounting the cleat to a structure in contact with surface 202.

In some embodiments, cleat 200 may include a protuberance 205 sized and configured to fit within indentation 109 in sensor 100 in which magnetic activation device 511 is to be removed prior to mounting sensor 100 onto cleat 200. Protuberance 205 may be sized and configured such that if device 511 is not removed, sensor 100 cannot be mounted onto cleat 200.

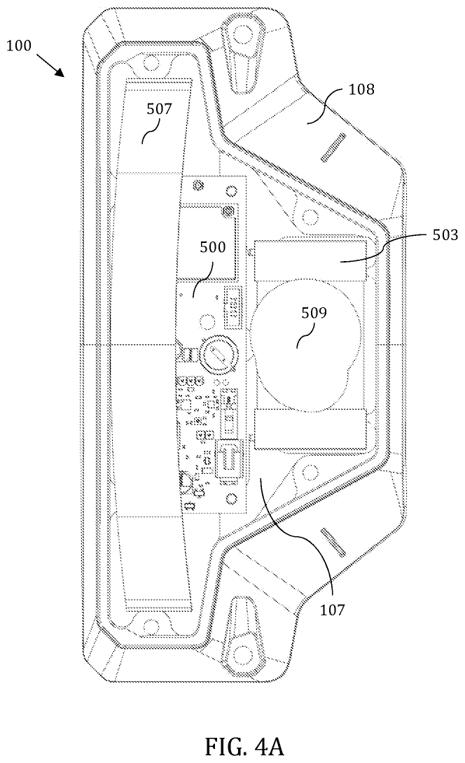

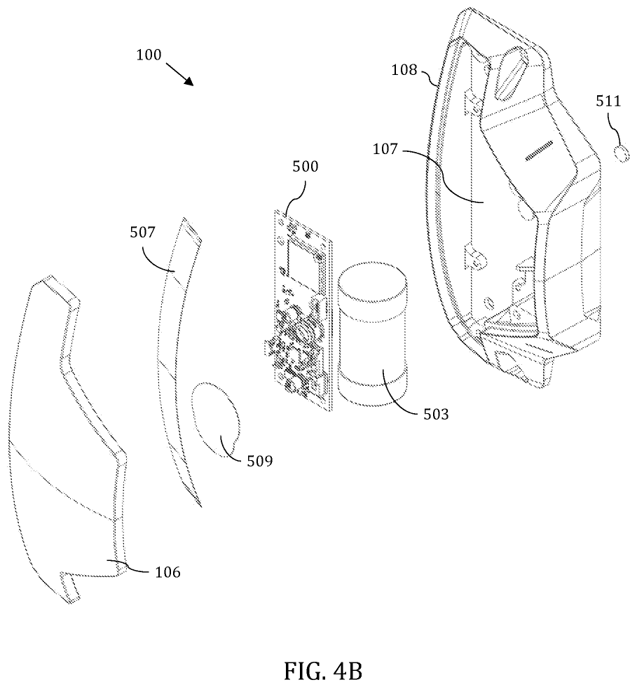

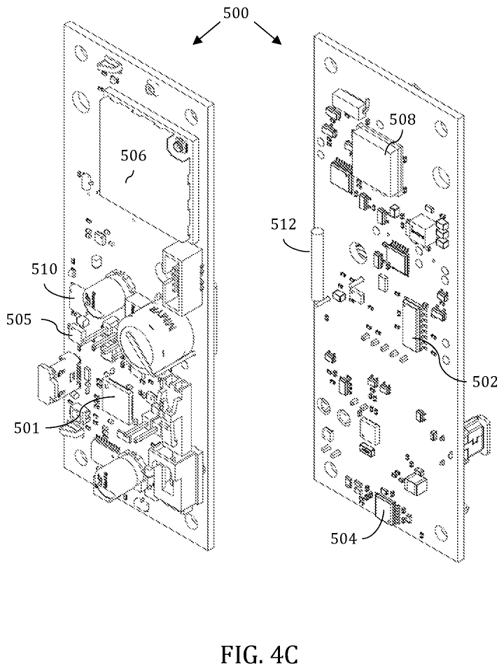

Referring now to FIGS. 4A, FIG. 4B, and FIG. 4C, sensor 100 may include a lid 106 (FIG. 4B) that may be coupled or otherwise affixed to sensor body 108 and covers an internal cavity 107 within said sensor body. Electronic components of sensor 100 may be configured within cavity 107 and, in some embodiments, comprise a primary circuit board 500, a microcontroller 501, a memory device 502, at least one battery 503, a battery fuel gauge 504, at least one sensing module 505, at least one wireless module 506, at least one wireless antenna 507, a GPS module 508, and a GPS antenna 509, a real time clock 510, and a reed relay 512.

In some embodiments, sensor body 108 may be primarily constructed of a corrosion-resistant metal including, but not limited to, aluminum or stainless steel, and lid 106 may be constructed primarily of a polymer. In some embodiments, sensor body 108 and lid 106 may be constructed primarily of a polymer. Constructing lid 106 from a non-conductive material is advantageous such that it allows antennae 507 and 509 to be configured internally within cavity 107 without interfering with electromagnetic communication of the antennae.

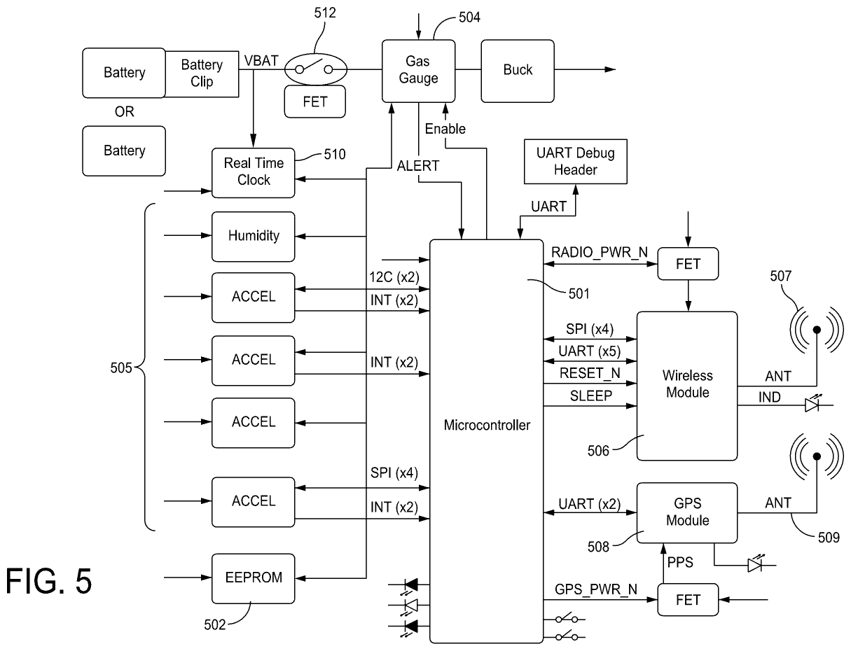

As is illustrated in FIG. 5, microcontroller 501 may be in signal communication with the memory device, the at least one sensing module 505, the battery fuel gauge 504, the at least one wireless module 506, the GPS module 508, and real time clock 510. The microcontroller controller may be configured to at least one of control and communicate with these devices. Battery fuel gauge 503 may be electrically connected to battery 503 and provides battery charge information to the microcontroller. Reed relay 512 may be electrically connected to battery 503. The at least one wireless module 506 may be electrically connected to the at least one wireless antenna 507 and GPS module 508 is electrically connected to GPS antenna 509.

In some embodiments, the sensor 100 may include at least one of a microprocessor, a real-time clock, a real-time controller, and an FPGA. In some embodiments, the at least one battery may be a lithium ion battery. In some embodiments, memory device 502 may be at least one of an EEPROM, FRAM, and flash memory device. In some embodiments, the at least one sensing module may include at least one of an accelerometer, a gyroscope, a temperature sensor, and a humidity sensor, to list only a few possibilities.

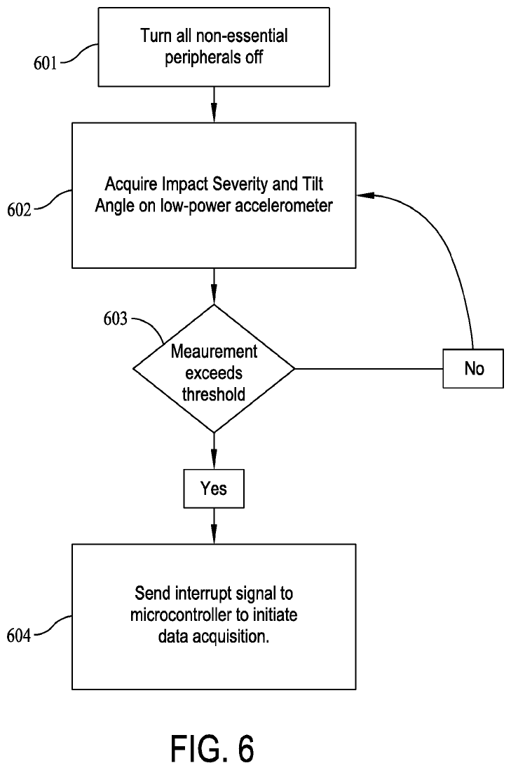

As is illustrated in FIG. 6, sensor 100 can conserve battery by disabling non-essential peripheral devices in a default very-low-power sleep state. In step 601, microcontroller 501, battery fuel gauge 503, at least one of the sensing modules 505, the at least one wireless module 506, GPS module 508, and other non-essential peripheral devices can be configured to operate in a very-low-power state. In some embodiments, at least one of the sensing modules 505 may be configured to operate in a low-power state, as shown in step 602, and provide an interrupt signal to microcontroller 501 when a measured parameter exceeds a predetermined threshold value, as shown in step 603. Said interrupt signal may be configured to initiate data acquisition such that microcontroller 501 sends a signal to at least one of the peripheral devices to switch into a higher-power data acquisition state, as shown in step 604.

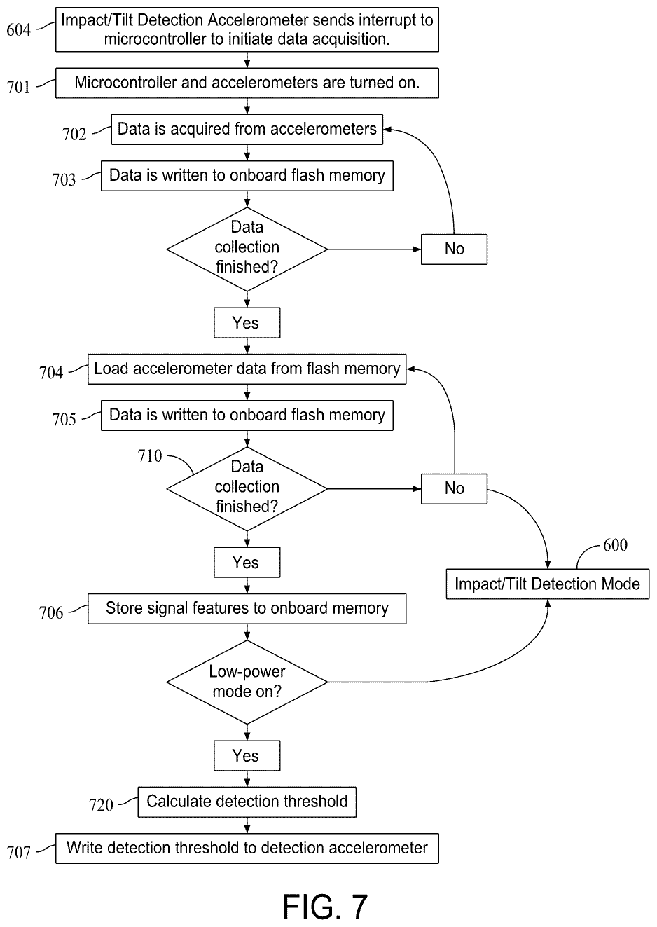

When sensor 100 is transitioned from sleep state 600 into the data acquisition state due to a triggering event, the data acquisition process illustrated in FIG. 7 may be initiated. In the data acquisition state, microcontroller 501 and at least one of the sensor modules 505 may be switched into a higher-power state, as shown in step 604, to measure physical parameters. In some embodiments, the data acquisition settings for sensing modules 505 may be different between the lower-power and higher-power sensing modes to prioritize minimal power consumption in the lower-power mode and to prioritize data quality in the higher-power mode. In the higher-power mode, microcontroller 501 may be configured to record the data acquired by sensing modules 505 in step 702 to memory device 502.

In some embodiments, the duration of the data measurement step 702, in which sensing modules 505 measure physical parameters in a higher-power state, may be determined by an event definition window setting. In some embodiments, said duration may be determined by the amplitude or another quantifiable parameter of the measurements during step 702.

The data recorded to memory device 502 may be loaded and processed to extract at least one signal feature in steps 704 and 705, respectively. The at least one signal feature may be recorded to memory device 502 in step 706, and the device may be placed back into the very-low-power sleep state 600. In some embodiments, data processing steps 704, 705, and 706 may be conducted in parallel to data collection steps 702 and 703.

In some embodiments, the at least one sensing module 505 may include a plurality of accelerometers, each capable of measuring acceleration on up to three orthogonal axes and each accelerometer furthermore having a different range of sensitivity to said acceleration such that sensor 100 may have a large dynamic range of sensitivity.

As is illustrated in FIG. 7, step 710 in the data acquisition process may include evaluating the measured values from each of the sensing modules 505 to determine if the measurement has exceeded a maximum range of sensitivity for said sensing module. If the measurement for a single parameter has not exceeded the maximum range on more than one sensing module, then the measurement collected on the sensing module having the smallest range may be recorded and the others are discarded. This process allows for the maximum accuracy over a larger dynamic range.

The signal feature extraction process in step 705 may include calculating at least one metric derived from the measured data that has at least one of a dimensionality and a size that are less than that of said measured data. Performing step 705 on sensor 100 advantageously reduces the power consumption compared to wirelessly transmitting the complete measurement and performing step 705 elsewhere.

One example of a signal feature may be a three-dimensional static tilt angle. In some embodiments, triaxial acceleration data measured by at least one accelerometer can be utilized to calculate the static tilt angle of sensor 100, and thereby the static tilt angle of structure 300, in three dimensions. These calculations may be performed as described below in the Calculation Appendix. In this case, the term “static” indicates that the calculation may be accurate if the inertial forces induced by the motion of sensor 100 are small relative to gravitational acceleration.

In some embodiments, the at least one sensing module 505 may include at least one gyroscope capable of measuring rotation around up to three orthogonal axes.

If the static condition is not met, i.e., if the inertial forces are not small relative to the gravitational force, a dynamic tilt measurement may be used to accurately calculate the three-dimensional tilt angle of sensor 100. The calculation of dynamic tilt may be performed by utilizing the triaxial rotational velocity measured by the at least one gyroscope to estimate the inertial forces due to rotation and adjusting the static tilt estimations accordingly. These calculations may be performed as described in the Calculation Appendix set forth below.

A detection threshold calculation may be performed in step 720 to adjust the threshold utilized in step 603 to trigger a data acquisition event. In some embodiments, the threshold may be a user-adjustable static value. In some embodiments, the threshold may be automatically increased or decreased with the objective of maintaining the total number of data acquisition events that occur in a given time period between a user-adjustable maximum and a user-adjustable minimum. In some embodiments, the threshold may be automatically calculated with the objective of maintaining said threshold above the average detected amplitude of the measured value by a user-adjustable amount.

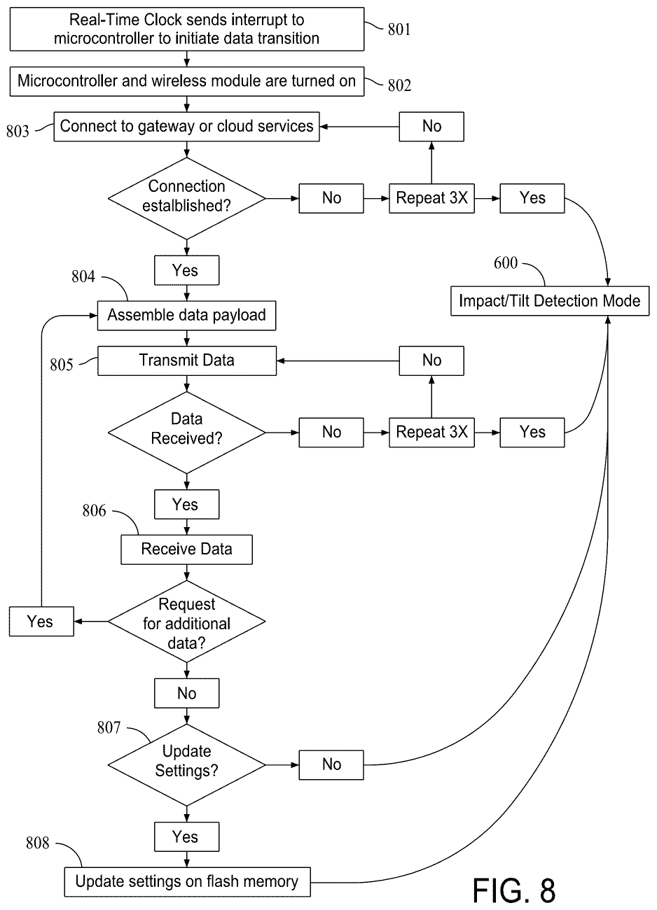

In addition to sleep state 600 and a data acquisition state, a third state of the sensor electronics may include a transmission state, as is illustrated in FIG. 8. Wireless module 506 and GPS module 508 may be configured to remain in a very-low-power condition unless microcontroller 501 supplies a signal to switch, as shown in step 802, into a higher-power operational state for the purposes of at least one of receiving and transmitting data by means of wireless antenna 507 and GPS antenna 509, respectively.

Wireless module 506 in conjunction with microcontroller 501 may establish a connection with a gateway to cloud services in step 803. In some embodiments, the connection may be wireless, although it should be understood that the connection may also be or include a wired connection. When a connection is established and authenticated, a data payload may be constructed and encrypted in step 804, and the data payload may be transmitted to a gateway in step 805. Following the transmission state, sensor 100 may be returned to sleep state 600.

The transmission state may include a data receiving step 806. Wireless module 506 in conjunction with microcontroller 501 can also be configured to receive awaiting data from the gateway, which may include settings modifications, requests for additional data, or firmware upgrades, or other data. If settings are received during step 806, said settings will be updated on memory device 502 in step 808.

In some embodiments, a transmission state may be activated on a user-adjustable time interval such that the real time clock 510 sends an interrupt signal to microcontroller 501 in accordance with said interval. In some embodiments, a transmission state may be activated based on a user-adjustable threshold for at least one of a minimum signal feature and a measured data amplitude. In some embodiments, a transmission state may be activated as after a user-adjustable number of data acquisition events.

Wireless module 506 and wireless antenna 507 may be configured to communicate via one or more wireless network protocols including Bluetooth, WiFi, ZigBee, HART, LoRa, or other wireless communication protocols. In some embodiments, wireless module 506 and wireless antenna 507 may be configured to communicate via 3G, 4G, 5G or other cellular communication networks.

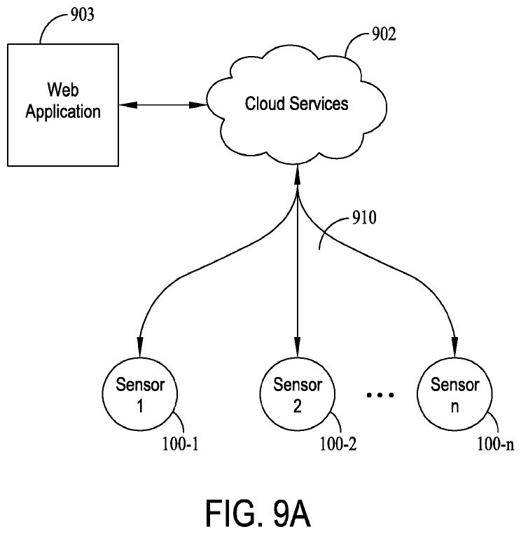

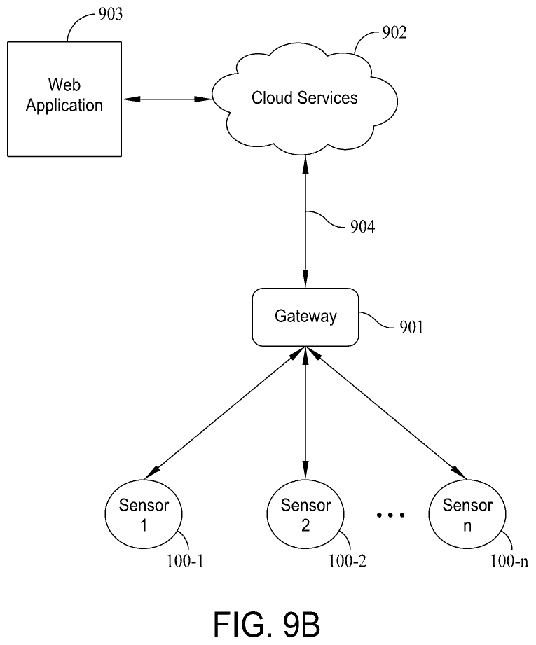

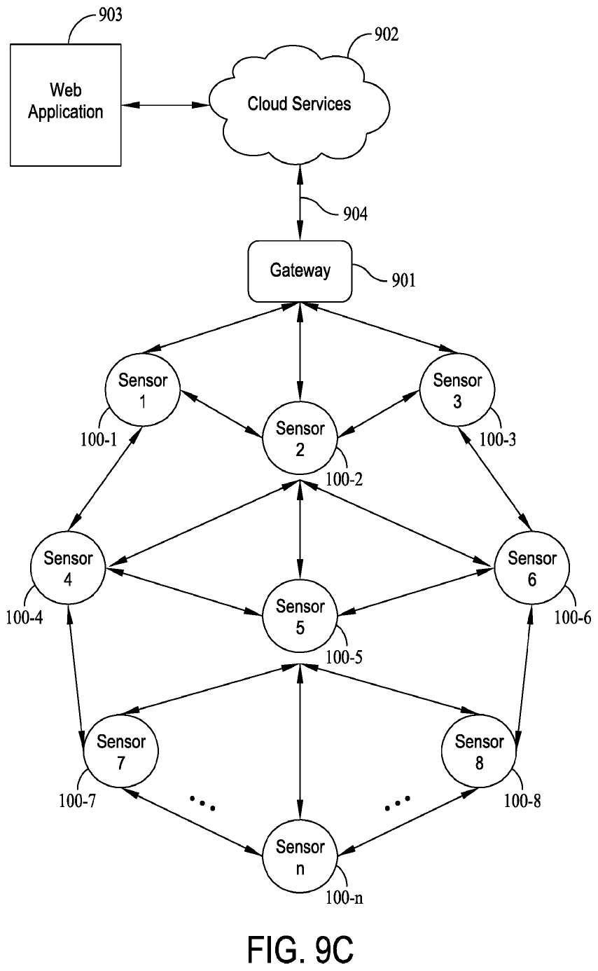

As is illustrated in FIG. 9A, FIG. 9B, and FIG. 9C, the wireless connection between sensor 100 and cloud services 902 may be one of a direct connection 910, a direct-to-gateway connection 920, or a mesh-to-gateway connection 930. The asset manager and other users may access the information transmitted by sensor 100 and may communicate with sensor 100 via a web application 903 that is in connection with cloud services 902.

In FIG. 9A, at least one sensor 100 may be in signal communication with cloud services 902 via a direct wireless connection 910. Each of sensors 100-1, 100-2, and 100-n may be in direct wireless communication with cloud services 902 independently of one another. In some embodiments, said direct connection may include a direct-to-cellular data connection.

In FIG. 9B, at least one sensor 100 may be in signal communication with cloud services 902 via a gateway device 901, a connection 904 between cloud services 902 and gateway 901, and as connection 920 between at least one sensor 100 (e.g., sensors 100-1, 100-2, . . . , 100-n). The connections 904, 920 may be wired and/or wireless as will be understood by one of ordinary skill in the art. In some embodiments, each of sensors 100-1, 100-2, and 100-n may be in direct communication with gateway device 901 independently of one another via a respective connection 920. In some embodiments, direct connection 920 between the at least one sensor 100 and gateway 901 may be a wireless network, such as a wireless connection based on a LoRa or similar network protocol, although it should be understood that other communication protocols may be used. In some embodiments, connection 904 between gateway 901 and cloud services 902 may include at least one of a wired internet connection, a wireless internet connection, a cellular connection, and a satellite connection.

In FIG. 9C, at least one sensor 100 may be in signal communication with cloud services 902 via a gateway device 901, a connection 904, and a connection 930. In some embodiments, each of sensors 100-1, 100-2, through 100-n may be in communication with gateway device 901 via a wireless mesh network 930, although other types of connections may be used. Within said mesh network, at least one data communication channel maybe established between at least one first sensor 100 and gateway 901 either via a direction connection to said gateway or via a connection established through at least one other sensor 100. Gateway device 901 may be in communication with cloud services 902 via connection 904, which may be a wired or wireless connection. In some embodiments, connection 930 between the at least one sensor 100 and gateway 901 may be a wireless mesh network based on one of a ZigBee, HART, or a similar mesh network protocol. In some embodiments, connection 904 between gateway 901 and cloud services 902 may include at least one of a wired internet connection, a wireless internet connection, a cellular connection, and a satellite connection.

The sensors disclosed herein may be configured to utilize one or more design features to maximize battery life including a very-low-power sleep state, adjustable thresholds to active the higher-power data acquisition state, and feature extraction to reduce the size and dimensionality of data that is transmitted.

Sensor 100 may be advantageously designed to facilitate a simple, low-cost, user-friendly installation and commissioning process. The utilization of mounting cleat 200 facilitates easy installation on a wide range of structures. Furthermore, in some embodiments, sensor 100 may be initially commissioned by removing a magnetic activation device 511 that initiates the sensor startup and commissioning process without compromising the integrity of the environmental seal with due to a button or other activation method. When magnetic activation device 511 is removed from sensor 100, a magnetic reed relay 512 electrically connected to circuit board 500 within cavity 107 is closed, which initializes the device. In some embodiments, sensor 100 physically cannot be attached to cleat 200 until magnetic activation device 511 is removed.

### Calculation Appendix

The following is adapted from “A Guide to using IMU (Accelerometer and Gyroscope Devices) in Embedded Applications,” by Starlino Electronics, available online at http://www.starlino.com/imu_guide.html, which is incorporated by reference herein in its entirety.

### Accelerometers

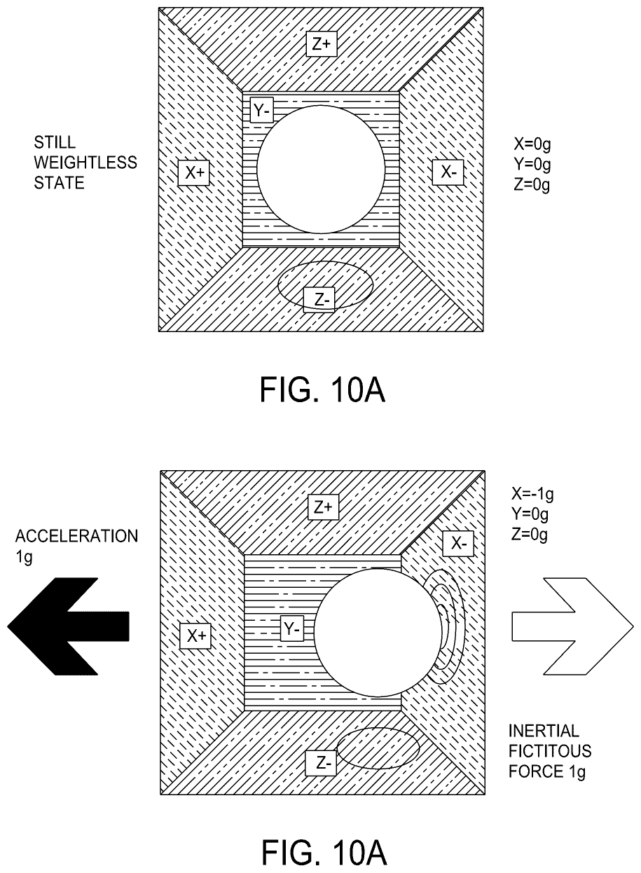

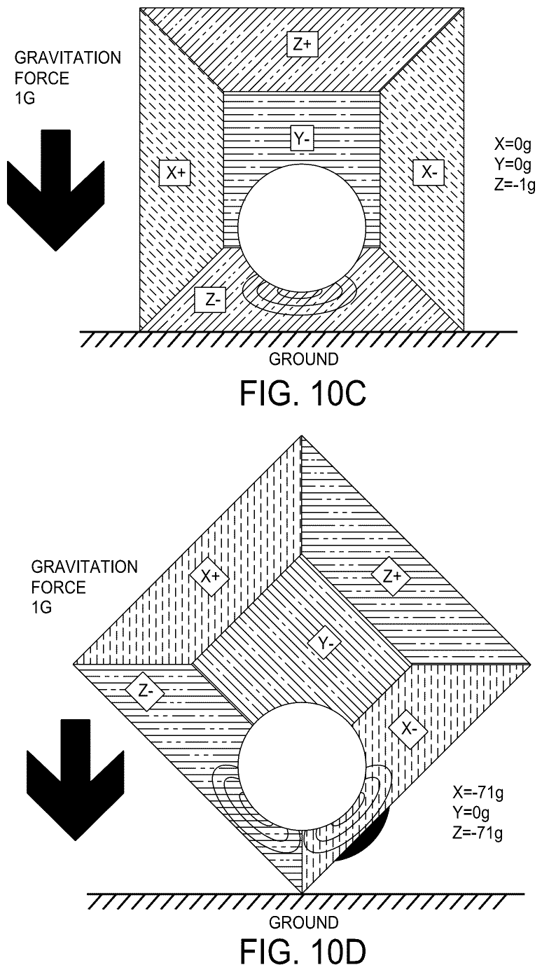

When thinking about accelerometers it is often useful to image a box in shape of a cube with a ball inside as shown in FIG. 10A.

If the box is disposed in a place with no gravitation fields or other fields that might affect the ball's position, then the ball will simply float in the middle of the box. For example, if the box is disposed in outer-space far-far away from any cosmic bodies, or if such a place is hard to find imagine at least a space craft orbiting around the planet where everything is in weightless state. In FIG. 10A, each axis has been assigned a pair of pressure-sensitive walls (note that the wall Y+ has been removed so that the ball is visible inside the box). If the box is suddenly moved to the left with acceleration 1 g=9.8 m/s², as shown in FIG. 10B, then the ball will hit the wall X−. The pressure force that the ball applies to the wall may be measured, which would generate an output a value of −1 g on the X axis.

An accelerometer will detect a force that is directed in the opposite direction from the acceleration vector. This force is often called an “Inertial Force” or a “Fictitious Force.” An accelerometer measures acceleration indirectly through a force that is applied to one of its walls (according to the example being described; one of ordinary skill in the art will understand that an actual accelerometer may include a spring or other pressure sensitive device). The force detected by an accelerometer may be can be caused by acceleration, but not always.

For example, if the model illustrated in FIG. 10A is placed on Earth, then the ball will fall on the Z-wall due to gravity and therefore will apply a force of 1 g on the bottom wall, as shown in FIG. 10C. In this case, the box is not moving, but the accelerometer would output a reading of −1 g on the Z axis due to the gravitational force. In theory, the applied force could be a different type of force. For example, if the ball is metallic and the box is place next to a magnet, then this may result in the ball moving so that it hits another wall. Thus, accelerometers may be configured to measure force—not necessarily acceleration of the accelerometer. It just happens that acceleration causes an inertial force that is captured by the force detection mechanism of an accelerometer.

While this model is not exactly how a MEMS sensor is constructed it is often useful in solving accelerometer related problems. There are actually similar sensors that have metallic balls inside, which are called tilt switches. However, these tilt sensors are more primitive and usually they can only tell if the device is inclined within some range or not, not the extent of inclination.

The previous description concerned analyzing an accelerometer output on a single axis, which is what is provided with single-axis accelerometers. An advantage of triaxial accelerometers is that they can detect inertial forces on all three axes. FIG. 10D shows the model box having been rotated 45 degrees to the right. As shown in FIG. 10D, the ball touches two walls: Z− and X−. The values of 0.71 g shown in FIG. 10D are not arbitrary, they are actually an approximation for

$$\sqrt{\frac{1}{2}} ,$$

and the reason for this will be understood after reading the following description.

While the previous examples described above with respect to FIGS. 10A-10C were useful to understand how an accelerometer interacts with outside forces, it is more practical to perform calculations if we fix the coordinate system to the axes of the accelerometer and imagine that the force vector rotates around the accelerometer. FIG. 10E illustrates a model in which each axis is perpendicular to respective faces of the box used in the previous model illustrated in FIGS. 10A-10C. The vector R is the force vector that the accelerometer is measuring (it could be either the gravitation force or the inertial force from the examples above or a combination of both). Rx, Ry, Rz are projection of the R vector on the X, Y,Z axes and have the following relationship:

$${R}^{2} = {R}_{X}^{2} + {R}_{Y}^{2} + {R}_{Z}^{2} . \qquad Eq . 1$$

Equation 1 above is basically the equivalent of the Pythagorean theorem in three dimensions (“3D”). Previously, it was stated that the values of

$$\sqrt{\frac{1}{2}} , \sim 0.71$$

is not random. If these values are plugged into Equation 1 above, after recalling that our gravitation force was 1 g, the following can be verified by substituting

$$R = 1 ; {R}_{X} = - \sqrt{\frac{1}{2}} ; {R}_{Y} = 0 ; and {R}_{Z} = - \sqrt{\frac{1}{2}}$$

into Equation 1:

$${1}^{2} = {( - \sqrt{\frac{1}{2}} )}^{2} + {0}^{2} + {( - \sqrt{\frac{1}{2}} )}^{2}$$

The values of Rx, Rr, Rz are actually linearly related to the values that real-life accelerometer will output and may be used for performing various calculations. Most accelerometers fall in two categories: digital and analog. Digital accelerometers will output information using a serial protocol like I2C, SPI, or USART, while analog accelerometers output a voltage level within a predefined range that may be converted to a digital value using an ADC (analog-to-digital converter) module. Some microcontrollers have built-in ADC modules while others may need external components to perform ADC conversion. Regarless of the type of ADC module used, the output will be a value in a certain range. For example a 10-bit ADC module may output a value in the range of 0 . . . 1023, note that 1023=2¹⁰−1. A 12-bit ADC module may output a value in the range of 0 . . . 4095, note that 4095=2¹²−1.

Considering a simple example. Suppose a 10-bit ADC module provides the following values for the three-accelerometer channels (axes):

$$AdcRx = 586$$

$$AdcRy = 630$$

$$AdcRz = 561$$

Each ADC module will have a reference voltage. In this example, assume the reference voltage is 3.3V. To convert a 10-bit ADC value to voltage, the following formula may be used:

$${V}_{Rx} = A D {C}_{Rx} \times \frac{{V}_{ref}}{1023}$$

For an 8-bit ADC, the last divider would be 255=2⁸−1, and for a 12-bit ADC, the last divider would be 4095=2¹²−1. Applying this formula to all three channels (axes) yields the following values, with the results rounded to two decimal points.

$${V}_{Rx} = 586 \times \frac{3.3 V}{1023} \approx 1.89 V$$

$${V}_{Rx} = 630 \times \frac{3.3 V}{1023} \approx 2.03 V$$

$${V}_{Rx} = 561 \times \frac{3.3 V}{1023} \approx 1.81 V$$

Each accelerometer may have a zero-g voltage level, which value may be found in a specification for a particular accelerometer. This is the voltage that corresponds to 0 g. To get a signed voltage value, a shift from this level may be calculated. For example, if the 0 g voltage level is V_{zeroG}=1.65V, then the voltage shifts from zero-g voltage may be calculated as follows:

$${Δ V}_{Rx} = 1.89 V - 1.65 V = 0.24 V$$

$${Δ V}_{Ry} = 2.03 V - 1.65 V = 0.38 V$$

$${Δ V}_{Rz} = 1.81 V - 1.65 V = 0.16 V$$

The accelerometer readings are in volts; not in g (9.8 m/s²). Accordingly, to do the final conversion, the accelerometer sensitivity, usually expressed in mV/g, may be applied. For example, if the sensitivity=478.5 mV/g=0.4785V/g, which value may be identified in a specification, then the final force values expressed in g may be calculated use the following formula:

$${R}_{X} = \frac{Δ {V}_{R x}}{Sens i t i v i t y}$$

$${R}_{X} = \frac{0.24 V}{0.4 \; 785 V / g} \approx 0.5 g$$

$${R}_{Y} = \frac{0.38 V}{0.4 \; 785 V / g} \approx 0.79 g$$

$${R}_{Z} = \frac{0.16 V}{0.4 \; 785 V / g} \approx 0.33 g$$

It should be understood that the foregoing may be combined into a single formula.

$${R}_{X} = ( \frac{A D {C}_{R x} \times {V}_{r e f}}{1023} - {V}_{z e r o G} ) / Sensitivity$$

$${R}_{Y} = ( \frac{A D {C}_{R y} \times {V}_{r e f}}{1023} - {V}_{z e r o G} ) / Sensitivity {R}_{Z} = ( \frac{A D {C}_{R z} \times {V}_{r e f}}{1023} - {V}_{z e r o G} ) / Sensitivity . \qquad Eq . 2$$

All three components (axes) may be used to define an inertial force vector. If the device (e.g., gyroscope) is not subject to other forces other than gravitation, then it can be assumed this is the direction of the gravitation force vector. To calculate inclination of device relative to the ground, then the angle between this vector and Z-axis may be calculated. The per-axis direction of inclination can be split into two components: inclination on the X- and Y-axes that can be calculated as the angle between gravitation vector and X- and Y-axes. Calculating these angles may be performed as described below, which description refers back to the previously discussed accelerometer model with some additional notations, and as shown in FIG. 10F.

The angles of interest are the angles between X-, Y-, and Z-axes and the force vector R. These angles may be defined as Axr, Ayr, Azr. From the right-angle triangle formed by R and Rx, the following calculations may be performed:

$$cos ( Axr ) = \frac{{R}_{X}}{R}$$

$$cos ( A y r ) = \frac{{R}_{Y}}{R}$$

$$cos ( A z r ) = \frac{{R}_{Z}}{R}$$

The value of R may be deducted from Equation 1, as follows:

$$R = \sqrt{{R}_{X}^{2} + {R}_{Y}^{2} + {R}_{Z}^{2}}$$

The angles may be determined by using the arccos ( ) function (i.e., the inverse cos ( ) function):

$$Axr = arccos ( \frac{{R}_{X}}{R} )$$

$$Ayr = arccos ( \frac{{R}_{Y}}{R} )$$

$$Azr = arccos ( \frac{{R}_{Z}}{R} )$$

The following triplet is often called the “Direction Cosine,” and it basically represents the unit vector (vector with length 1) that has same direction as the R vector.

$$cos X = cos ( A x r ) = Rx / R$$

$$cos Y = cos ( A y r ) = Ry / R$$

$$cos Z = cos ( A z r ) = Rz / R$$

Using the foregoing, the following may be verified:

$$\sqrt{cos {X}^{2} + cos {Y}^{2} + cos {Z}^{2} = 1}$$

This property absolves monitoring the modulus (length) of R vector. If only the direction of the inertial vector is of interest, it makes sense to normalize its modulus in order to simplify other calculations.

### Gyroscope

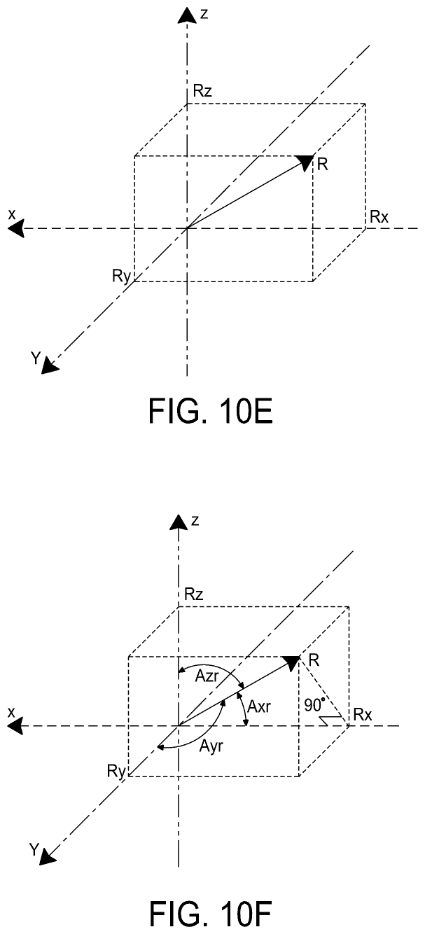

FIG. 11 represents a model for a gyroscope. Each gyroscope channel may measure the rotation around one of the axes. For instance a two-axes gyroscope may measure the rotation around (or some may say “about”) the X- and Y-axes. To express this rotation in numbers the following notations are defined:

Rxz—is the projection of the inertial force vector R on the XZ plane

Ryz—is the projection of the inertial force vector R on the YZ plane

From the right-angle triangle formed by Rxz and Rz and using the Pythagorean theorem provides:

$${R}_{xz}^{2} = {R}_{x}^{2} + {R}_{z}^{2}$$

$${R}_{yz}^{2} = {R}_{y}^{2} + {R}_{z}^{2}$$

It may also be noted that also note that R²=R_{xz}²+R_{y}², which can be derived from Equation 1 above. It may also be derived from right-angle triangle formed by R and Ryz:

$${R}^{2} = {R}_{yz}^{2} + {R}_{x}^{2}$$

However, the angle between the Z-axis and the Rxz, Ryz vectors may be defined as follows:

Axz—is the angle between the Rxz (projection of R on XZ plane) and Z-axis; and

Ayz—is the angle between the Ryz (projection of R on YZ plane) and Z-axis.

Gyroscopes measure the rate of changes of the angles defined above. In other words, a gyroscope may output a value that is linearly related to the rate of change of these angles. To explain this, assume that a measurement of the rotation angle around the Y-axis (e.g., the Axz angle) at time t0 has been made and is defined as Axz0. This angle may then measured later, at time t1, and this measurement may be Axz1. The rate of change may be calculated as follows:

$${Rate}_{A x z} = \frac{{A}_{X Z 1} - {A}_{XZ 0}}{{t}_{1} - {t}_{0}}$$

If Axz is expressed in degrees, and time in seconds, then this value will be expressed in deg/s. This is what a gyroscope measures. In practice, a gyroscope (unless it is a special digital gyroscope) will rarely provide a value expressed in deg/s. Same as for accelerometers. Instead, an ADC value typically may be provided that will need to be converted to deg/s using a formula similar to Equation 2, which was defined above for an accelerator. A formula to convert the ADC to deg/s for a gyroscope, assuming a 10-bit ADC module (for 8-bit ADC replace 1023 with 255, for 12 bit ADC replace 1023 with 4095), is as follows:

$${Rate}_{A x z} = ( \frac{A d c G y r o X Z \times V r e f}{1023} - VzeroRate ) / Sensitivity {Rate}_{A y z} = ( \frac{A d cGyroYZ \times Vref}{1023} - VzeroRate ) / Sensitivity \qquad Eq . 3$$

AdcGyroXZ and AdcGyroYZ may be obtained from the ADC module and represent the channels that measure the rotation of projection of the R vector in the XZ and YZ planes, respectively, which is the equivalent to saying rotation was done around Y- and X-axes respectively.

Vref is the ADC reference voltage. In the following description, 3.3V will be used, but it should be understood that other ADC reference voltages may be used.

VzeroRate is the zero-rate voltage, which may correspond to the voltage that the gyroscope outputs when it is not subject to any rotation. This value typically may be found in the specification for a gyroscope, although most gyros will suffer slight offset after being soldered. Accordingly, the measure VzeroRate for each axis output should be measured using a voltmeter. This value will not change over time once the gyro was soldered. However, if this value does vary, then a calibration routine may be used in which the VzeroRate voltage is measured before device start-up while the device is held still. The measured value may be stored and then used as VzeroRate. For an Acc_Gyro board, the VzeroRate voltage may be 1.23V, for example. Again, other VzeroRate voltages may be used.

Sensitivity is the sensitivity of the gyroscope and may be expressed in mV/(deg/s), which is often written as mV/deg/s. The sensitivity basically identifies how many mV will the gyroscope output increase, if the rotation is increased by one deg/s. The sensitivity of Acc_Gyro board is for example 2 mV/deg/s or 0.002V/deg/s. For example, assume an ADC module returned following values:

$$AdcGyroXY = 571$$

$$AdcGyroXZ = 323$$

Using the above formula and using the specs parameters of an Acc_Gyro board provides:

$${Rate}_{A x z} = ( \frac{571 \times 3.3 V}{1023} - 1.23 V ) / 0.002 V / deg / s \approx 306 deg / s$$

$${Rate}_{Ayz} = ( \frac{323 \times 3.3 V}{1023} - 1.23 V ) / 0.002 V / deg / s \approx 94 deg / s$$

In other words the device rotates around the Y-axis (e.g., it rotates in the XZ plane) with a speed of 306 deg/s and around the X-axis (e.g., it rotates in YZ plane) with a speed of −94 deg/s. Note that the negative sign means that the device rotates in the opposite direction from the conventional positive direction. By convention, one direction of rotation is positive. A good gyroscope specification sheet will show which direction is positive, otherwise it may be determined by experimenting with the device and noting which direction of rotation results in increasing voltage on the output pin. This may be done using an oscilloscope since as soon as the rotation stops, the voltage will drop back to the zero-rate level. If using a multimeter, constant rotation should be maintained for at least few seconds and note the voltage during this rotation, then compare it with the zero-rate voltage. If it is greater than the zero-rate voltage it means that direction of rotation is positive.

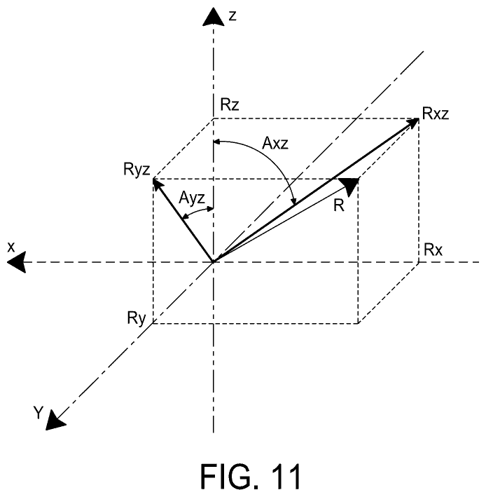

To use a combination inertial measurement unit (“IMU”) device that combines an accelerometer and a gyroscope, the coordinate systems of the gyroscope and accelerometer are aligned. One way to align these coordinate systems is to choose the coordinate system of accelerometer as your reference coordinate system. Most accelerometer data sheets will display the direction of X, Y,Z axes relative to the image of the physical chip or device. The directions of the X-, Y-, and Z-axes as shown in specifications for an Acc_Gyro board are shown in FIG. 12.

Additionally, the gyroscope outputs that correspond to RateAxz, RateAyz values, discussed above, are identified, and it is determined if these outputs need to be inverted due to physical position of gyroscope relative to the accelerometer. It should not be assumed that if a gyroscope has an output marked X or Y, it will correspond to any axis in the accelerometer coordinate system, even if this output is part of an IMU unit. The best way is to test the outputs to determine to which axis they correspond. The following is one example of a method for determining which output of a gyroscope corresponds to RateAxz value discussed above.

The device may be placed in a first position, which may be a horizontal position. In such an orientation, both the X and Y outputs of an accelerometer should output the zero-g voltage. For example, as noted above, for an Acc_Gyro board, this voltage is 1.65V. However, other voltages may be used.

The device may then be rotated a first axis, such as the Y-axis. Put another way, the device may be rotated in a first plane, which may be t XZ plane so that X and Z accelerometer outputs change and the Y output remains constant.

While the device rotates at a constant speed, the other gyroscope outputs that remain constant are noted. The gyroscope output that changes during the rotation around Y axis (rotation in XZ plane) will provide the input value for AdcGyroXZ, from which we calculate RateAxz.

The rotation direction may be confirmed. For example, in some situations, the RateAxz value may need to be inverted due to physical position of gyroscope relative to the accelerometer.

The previously discussed steps may be repeated, but other outputs may be monitored. For example, while the device is rotated about the Y-axis, the X output of accelerometer (AdcRx in our model) may be monitored. If the AdcRx value grows (the first 90 degrees of rotation from horizontal position), then the AdcGyroXZ should decrease. This is due to the fact that the gravitation vector is being monitored when device rotates in one direction and when the vector rotates in an opposite direction (relative to the device coordonate system, which we are using). So, otherwise RateAxz may need to be inverted, which can be achieved by introducing a sign factor in Eq. 3, as follows:

$${Rate}_{A x z} = {Invert}_{A x z} \times ( \frac{A D {C}_{G y r o X Z} \times {V}_{r e f}}{1023} - {V}_{z e r o R a f e} ) / Sensitivity ,$$

where Invert_{Axz} is a 1 or −1.

The same test can be done for RateAyz by rotating the device around the X-axis, and it can be identified which gyroscope output corresponds to RateAyz, and if the output needs to be inverted. Once the value for InvertAyz has been obtained, the following formula may be used to calculate RateAyz:

$${Rate}_{Ayz} = {Invert}_{Ayz} \times ( \frac{A D {C}_{GyroYZ} \times {V}_{ref}}{1023} - {V}_{zeroRate} ) / Sensitivy$$

To perform these tests on an Acc_Gyro board, the following results would be provided: (1) the output pin for RateAxz is GX4 and InvertAxz=1; and (2) the output pin for RateAyz is GY4 and InvertAyz=1.

From this point on, it will be assumed that the IMU has been setup in such a way that the correct values for Axr, Ayr, Azr (discussed above with respect to the accelerometer) and RateAxz, RateAyz (discussed above with respect to gyroscopes) may be calculated. The relationship between these values that are useful in obtaining a more accurate estimation of the inclination of the device relative to the ground plane are now described.

It should be understood that accelerometer data cannot always be trusted for several reasons. For example, an accelerometer measures inertial force, such a force can be caused by gravitation (and ideally only by gravitation), but it might also be caused by acceleration (movement) of the device. As a result, even if accelerometer is in a relatively stable state, it is still sensitive to vibration and mechanical noise in general. This is the main reason why IMU systems may use a gyroscope to smooth out any accelerometer errors.

Gyroscopes are not free from noise because they measure rotation and therefore are less sensitive to linear mechanical movements than accelerometers. However, gyroscopes have other types of problems, such as drift (i.e., not coming back to zero-rate value when rotation stops). By averaging data that comes from an accelerometer and a gyroscope, a relatively better estimate of current device inclination may be obtained than would obtained by using the accelerometer data alone.

The direction of the gravitational force vector R=[Rx,Ry,Rz], which is used to derive other values like Axr,Ayr,Azr or cosX,cosY,cosZ, may also be used to provide an indication of the inclination of our device relative to the ground plane. To reduce the effect of noise, the accelerometer measurements may be redefined. For example, Racc may be the inertial force vector as measured by accelerometer and may include the components (projections on the X-, Y-, and Z-axes):

$${R}_{xAcc} = ( \frac{A D {C}_{Rx} \times {V}_{ref}}{1023} - {V}_{zeroRate} ) / Sensitivy$$

$${R}_{yAcc} = ( \frac{A D {C}_{Ry} \times {V}_{ref}}{1023} - {V}_{zeroRate} ) / Sensitivy$$

$${R}_{zAcc} = ( \frac{A D {C}_{Rz} \times {V}_{ref}}{1023} - {V}_{zeroRate} ) / Sensitivy$$

The foregoing set of values may be obtained purely from accelerometer ADC values. This set of values will be referred to as a “vector,” and the following notation may be used:

$$Racc = [ RxAcc , RyAcc , RzAcc ]$$

Because the components of Racc may be obtained from accelerometer data, it may be input into the algorithm discussed below. However, because Racc measures the gravitation force, the length of this vector defined as follows is equal or close to 1 g.

$$\vert Racc \vert = \sqrt{{R}_{xAcc}^{2} + {R}_{yAcc}^{2} + {R}_{zAcc}^{2}}$$

The vector may be normalized as follows:

$$Racc ( normalized ) = [ \frac{{R}_{xAcc}}{\vert Racc \vert} , \frac{{R}_{yAcc}}{\vert Racc \vert} , \frac{{R}_{zAcc}}{\vert Racc \vert} ]$$

Normalizing may ensure that the length of normalized Racc vector is always 1. The next vector is Rest, which will be the output of the algorithm, and represents corrected values based on gyroscope data and past estimated data. Rest is defined as follows:

$$Rest = [ RxEst , RyEst , RzEst ]$$

The following is a high-level description of the functions performed by the algorithm. For example, the accelerometer may output a value indicating that the device is at position Racc. The output of the accelerometer is corrected with the gyroscope data as well as with past Rest data, and a new output vector, Rest, is output. A more detailed description of the algorithm is now described.

The sequence may begin by trusting the accelerometer output and assigning:

$$Rest ( 0 ) = Racc ( 0 )$$

As noted above, Rest and Racc are vectors, so the above equation is just a simple way to write 3 sets of equations, and avoid repetition:

$$RxEst ( 0 ) = RxAcc ( 0 )$$

$$RyEst ( 0 ) = RyAcc ( 0 )$$

$$RzEst ( 0 ) = RzAcc ( 0 )$$

Regular measurements may be made at equal time intervals of T seconds, and the new measurements may be defined as Racc(1), Racc(2), Racc(3), etc. New estimates at each time intervals Rest(1), Rest(2), Rest(3), etc. may also be generated.

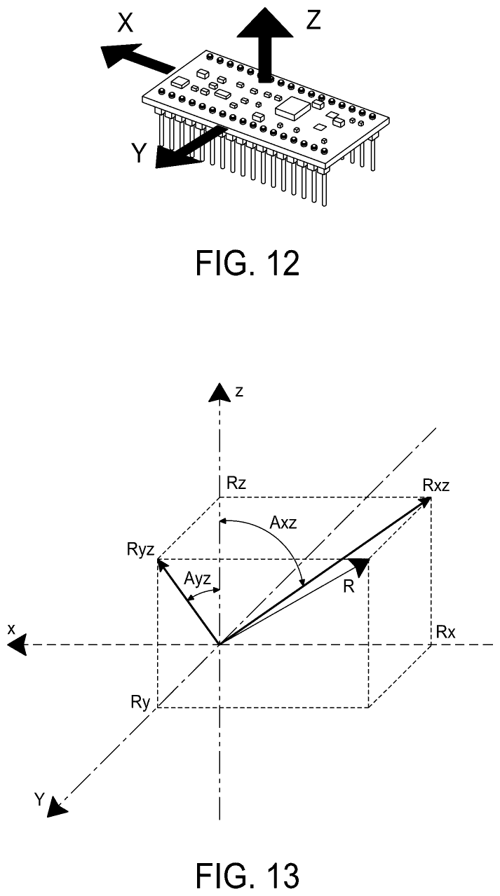

At interval n, there may be two known sets of values that may be used: Rest(n−1), i.e., the previous estimate, with Rest(0)=Racc(0); and Racc(n), i.e., the current accelerometer measurement. Before calculating Rest(n), a new measured value may be introduced, which value can be obtained from the gyroscope and a previous estimate. This value will be referred to as Rgyro and will include the following three components: Rgyro=[RxGyro,RyGyro,RzGyro]. The calculation of Rgyro is now described with respect to the model illustrated in FIG. 13. From the right-angle triangle formed by Rz and Rxz, the following may be derived:

$$tan ( Axz ) = Rx / Rz = > Axz = atan 2 ( Rx , Rz ) .$$

Atan2 is similar to atan, except it returns values in range of (−PI,PI) as opposed to (−PI/2,PI/2), as returned by atan. Thus, Atan2 takes 2 arguments instead of one and allows conversion of the two values of Rx, Rz into angles in the full range of 360 degrees (−PI to PI). Knowing RxEst(n−1) and RzEst(n−1), the following may be determined:

$$Axz = atan 2 ( RxEst ( n - 1 ) , RzEst ( n - 1 ) ) .$$

As noted above, a gyroscope measures the rate of change of the Axz angle. The new angle Axz(n) may be estimated as follows:

$$Axz = Axz ( n - 1 ) + RateAxz ( n ) * T$$

The value of RateAxz may be obtained from a gyroscope ADC readings. A more precise formula can use an average rotation rate calculated as follows:

$$RateAxzAvg = \frac{RateAz ( n ) + RateAxz ( n - 1 )}{2}$$

$$Axz ( n ) = Axz ( n - 1 ) + RateAxzAvg * T$$

The same method may be used to determine:

$$Ayz ( n ) = Ayz ( n - 1 ) + RateAyz ( n ) * T$$

The values of Axz(n) and Ayz(n) may be used to determine RxGyro/RyGyro. For example, from Eq. 1 the length of vector Rgyro may be written as follows:

$$\vert Rgyro \vert = \sqrt{{RxGryo}^{2} + {RyGyro}^{2} + {RzGyro}^{2}}$$

Because the Racc vector has been normalized, it may be assumed that it's length of 1 has not changed after rotation. Accordingly, it is relatively safe to assume: |Rgyro|=1. The short notation of x=RxGyro, y=RyGyro, z=RzGyro will be used for the rest of the description of the algorithm. Using the relations above, the equation may be rewritten:

$$x = \frac{x}{1} = \frac{x}{\sqrt{{x}^{2} + {y}^{2} + {z}^{2}}}$$

Dividing the numerator and denominator by \sqrt{x²+z²} yields:

$$x = \frac{\frac{x}{\sqrt{{x}^{2} + {z}^{2}}}}{\sqrt{\frac{{x}^{2} + {y}^{2} + {z}^{2}}{{x}^{2} + {z}^{2}}}}$$

Note that

$$\frac{x}{\sqrt{{x}^{2} + {z}^{2}}} = sin ( Axz ) ,$$

so:

$$x = \frac{sin ( Axz )}{\sqrt{1 + \frac{{y}^{2}}{{x}^{2} + {z}^{2}}}}$$

Multiplying the numerator and the denominator of fraction inside the square root by z² yields:

$$x = \frac{sin ( Axz )}{\sqrt{1 + \frac{{y}^{2} + {z}^{2}}{{z}^{2} ( {x}^{2} + {z}^{2} )}}}$$

Note that

$$\frac{z}{\sqrt{{x}^{2} + {z}^{2}}} = cos ( Axz ) and \frac{y}{z} = tan ( Ayz ) ,$$

so finally:

$$x = \frac{sin ( Axz )}{\sqrt{1 + {cos ( Axz )}^{2} + {tan ( Ayz )}^{2}}}$$

Going back to the original notation above yields:

$$RxGyro = \frac{sin ( Axz ( n ) )}{\sqrt{1 + {cos ( Axz ( n ) )}^{2} \times {tan ( Ayz ( n ) )}^{2}}}$$

$$RyGyro = \frac{sin ( Ayz ( n ) )}{\sqrt{1 + {cos ( Ayz ( n ) )}^{2} \times {tan ( Axz ( n ) )}^{2}}}$$

The above formulas may be simplified by dividing both parts of the fraction by sin (Axz(n)) and grouping terms, which ultimately yields:

$$Rzgyro = Sign ( RzGyro ) \sqrt{1 - {RxGyro}^{2} - {RyGyro}^{2}}$$

$$where ,$$

$$Sign ( RzGyro ) = 1 , when RzGyro \geq 0 ; and$$

$$Sign ( RzGyro ) = - 1 , when RzGyro < 0.$$

One simple way to estimate this is to take:

$$Sign ( RzGyro ) = Sign ( RzEst ( n - 1 ) )$$

In practice, when RzEst(n−1) is close to 0, it may be advisable to skip the gyro phase altogether and assign: Rgyro=Rest(n−1). Rz may be used as a reference for calculating Axz and Ayz angles and when Rz is close to 0, as values may overflow and trigger bad results. This is because large floating point numbers where tan( )/atan( ) function implementations may lack precision.

Based on the foregoing, the following values have been determined and/or calaculated: Racc, which are the current readings from an accelerometer, and Rgyro, which is obtained from Rest(n−1) and current gyroscope readings. A weighted average of these values may be used, as follows:

$$Rest ( n ) = \frac{Racc \times w 1 + Rgyro \times w 2}{w 1 + w 2}$$

The formulate may be simplified by dividing both numerator and denominator of the fraction by w1:

$$Rest ( n ) = \frac{Racc \frac{w 1}{w 1} + Rgyro \frac{w 2}{w 1}}{\frac{w 1}{w 1} + \frac{w 2}{w 1}}$$

Substituting

$$\frac{w 2}{w 1} = wGyro$$

yields:

$$Rest ( n ) = \frac{Racc + Rgyro \times wGyro}{1 + wGyro}$$

In the above formula, wGyro provides an indication as to how reliable the accelerometer data is and to what amount the gyroscope should be trusted over the accelerometer. The value of wGyro can be chosen experimentally, with values between 5-20 typically yield good results. The main difference of the foregoing algorithm from a Kalman filter is that this weight is relatively fixed. In contrast, with a Kalman filter, the weights are updated based on the measured noise of the accelerometer readings. Put another way, whereas a Kalman filter is focused at identifying the best theoretical result, the foregoing algorithm identifies a sufficient result for the application. The foregoing algorithm may be implemented such that wGyro is adjusted depending on some measured noise factors, but fixed values will work well for most applications.

Below are the updated estimated values:

$$RxEst ( n ) = \frac{RxAcc + RxGyro \times wGyro}{1 + wGyro}$$

$$RyEst ( n ) = \frac{RyAcc + RyGyro \times wGyro}{1 + wGyro}$$

$$RzEst ( n ) = \frac{RzAcc + RzGyro \times wGyro}{1 + wGyro}$$

Normalizing this vector yields:

$$R = \sqrt{{RxEst ( n )}^{2} + {RyEst ( n )}^{2} + {RzEst ( n )}^{2}}$$

$$RxEst ( n ) = \frac{RxEst ( n )}{R}$$

$$RyEst ( n ) = \frac{RyEst ( n )}{R}$$

$$RyEst ( n ) = \frac{RyEst ( n )}{R}$$

The loop may be repeated as desired.

The present invention can be embodied in the form of methods and apparatus for practicing those methods. The present invention can also be embodied in the form of program code embodied in tangible media, such as floppy diskettes, CD-ROMs, DVD-ROMs, Blu-ray disks, hard drives, or any other machine-readable storage medium, wherein, when the program code is loaded into and executed by a machine, such as a computer or processor, the machine becomes an apparatus for practicing the invention. The present invention can also be embodied in the form of program code, for example, whether stored in a storage medium, loaded into and/or executed by a machine or processor, or transmitted over some transmission medium, such as over electrical wiring or cabling, through fiber optics, or via electromagnetic radiation, wherein, when the program code is loaded into and executed by a machine, such as a computer or processor, the machine becomes an apparatus for practicing the invention. When implemented on a general-purpose processor, the program code segments combine with the processor to provide a unique device that operates analogously to specific logic circuits.

The foregoing outlines features of several embodiments so that those skilled in the art may better understand the aspects of the present disclosure. Those of ordinary skill in the art should appreciate that they may readily use the present disclosure as a basis for designing or modifying other processes and structures for carrying out the same purposes and/or achieving the same advantages of the embodiments introduced herein. Those of ordinary skill in the art should also realize that such equivalent constructions do not depart from the spirit and scope of the present disclosure, and that they may make various changes, substitutions, and alterations herein without departing from the spirit and scope of the present disclosure.

What is claimed is:

1. A sensor, comprising:
a housing defining an internal cavity and configured to be mounted to a structure;
at least one sensing module disposed within the internal cavity defined by the housing; and
a processor disposed within the internal cavity defined by the housing and in communication with the at least one sensing module, the processor configured to:
receive impact data from the at least one sensing module,
determine if the impact data exceeds a threshold value, and
initiate a data acquisition state if the impact data exceeds the threshold value.

2. The sensor of claim 1, wherein the housing includes:
a first portion defining the internal cavity; and
a second portion configured to mate with the first portion, the second portion including a first surface configured to be mounted to the structure.

3. The sensor of claim 2, wherein the second portion includes a cleat, the cleat defining at least one aperture sized and configured to receive a strap for mounting the cleat to the structure.

4. The sensor of claim 3, wherein the cleat includes:
a first surface configured to engage the structure; and
a second surface disposed opposite the first surface, the second surface configured to engage the first portion of the housing.

5. The sensor of claim 4, wherein the second surface of the cleat includes a protuberance extending from the second surface, the protuberance sized and configured to be received within an indentation defined by the first portion of the housing.

6. The sensor of claim 1, wherein the first portion of the housing includes:
a body formed from a first material; and
a lid formed from a second material that is different from the first material, the second material being a non-conductive material.

7. The sensor of claim 1, wherein the sensing module includes at least one of an accelerometer or a gyroscope.

8. The sensor of claim 1, wherein the processor, in the data acquisition state, is configured to:
acquire data from at least one accelerometer; and
store the data acquired from the at least one accelerometer in a memory that is in communication with the processor.

9. The sensor of claim 8, further comprising a communication module disposed in the internal cavity and in communication with the processor, the communication module configured to transmit data to a gateway device.

10. The sensor of claim 9, wherein the data transmitted to the gateway device is based on data acquired from the at least one accelerometer.

11. The sensor of claim 8, wherein the data acquired from the at least one accelerometer includes triaxial acceleration data.

12. A method, comprising:
receiving, at a processor disposed within an internal cavity defined by a housing of a sensor, impact data from at least one sensing module that is disposed within the internal cavity and in communication with the processor;
determining, by the processor, if the impact data exceeds a threshold value; and
initiating, by the processor, a data acquisition state if the impact data exceeds the threshold value,
wherein the housing is mounted to a structure.

13. The method of claim 12, wherein the data acquisition state includes:
acquiring data from at least one accelerometer; and
storing the data acquired from the at least one accelerometer in a local memory.

14. The method of claim 13, further comprising:
transmitting data to a gateway device, the data transmitted to gateway device based on the data acquired from the at least one accelerometer.

15. The method of claim 13, wherein the data acquisition state includes transitioning the sensing module into a low-power state after storing the data acquired from the at least one accelerometer in a local memory.

16. A computer readable storage medium storing program code, the program code, when executed by a processor, causes the processor to perform a method, the method comprising:
receiving impact data from at least one sensing module,
determining if the impact data exceeds a threshold value, and
initiating a data acquisition state if the impact data exceeds the threshold value.

17. The computer readable storage medium of claim 16, wherein the method includes:
acquiring data from at least one accelerometer; and
storing the data acquired from the at least one accelerometer.

18. The computer readable storage medium of claim 17, further comprising causing the data acquired from the at least one accelerometer to be transmitted to a gateway device.

19. A system, comprising:
a gateway device; and
at least one sensor communicatively coupled to the gateway device, the at least one sensor comprising:
a housing having a first surface and a second surface disposed opposite the first surface, the first surface configured to be disposed adjacent to a structure, the housing defining an internal cavity;
at least one sensing module disposed within the internal cavity;
a communication module disposed within the internal cavity; and
a processor disposed within the internal cavity and in communication with the at least one sensing module and the communication module, the processor configured to:
receive impact data from the at least one sensing module,
determine if the impact data exceeds a threshold value,
initiate a data acquisition state if the impact data exceeds the threshold value, and
cause the communication module to transmit data acquired during the data acquisition state to the gateway device.

20. The system of claim 19, wherein the data acquired during the data acquisition state includes triaxial acceleration data.

21. The system of claim 19, wherein the housing includes:
a first portion defining the internal cavity; and
a second portion configured to mate with the first portion, the second portion including a first surface configured to be mounted to the structure.

22. The system of claim 21, wherein the second portion includes a cleat, the cleat defining at least one aperture sized and configured to receive a strap for mounting the cleat to the structure.

23. The system of claim 22, wherein the cleat includes:
a first surface configured to engage the structure; and
a second surface disposed opposite the first surface, the second surface configured to engage the first portion of the housing.

24. The system of claim 23, wherein the second surface of the cleat includes a protuberance extending from the second surface, the protuberance sized and configured to be received within an indentation defined by the first portion of the housing.
